(19) United States
(12) Patent Application Publication
(10) Pub. No.: US 2025/0113065 A1
(43) Pub. Date: Apr. 3, 2025

(54) TECHNIQUES FOR DEBANDING IN THE IN-LOOP FILTERING STAGE OF A VIDEO CODING PIPELINE

(71) Applicant: NETFLIX, INC., Los Gatos, CA (US)

(72) Inventor: Andrey NORKIN, Campbell, CA (US)

(21) Appl. No.: 18/904,037

(22) Filed: Oct. 1, 2024

Related U.S. Application Data
(60) Provisional application No. 63/587,406, filed on Oct. 2, 2023.
(60) Provisional application No. 63/588,667, filed on Oct. 6, 2023.

(51) Int. Cl. H04N 19/86; H04N 19/117; H04N 19/147; H04N 19/176; H04N 19/82

(52) U.S. Cl. CPC H04N 19/86; H04N 19/117; H04N 19/147; H04N 19/176; H04N 19/82

(57) ABSTRACT

In various embodiments, a technique for reducing banding artifacts in decoded video data includes receiving a first block of reconstructed samples associated with a frame of encoded video data, applying a first filter to a first reconstructed sample included in the first block of reconstructed samples to generate a first filtered sample, determining that a first randomized dithering operation associated with the first filter is has been activated, applying the first randomized dithering operation to the first filtered sample to generate a first dithered sample, and generating a first portion of decoded video data based on the first dithered sample.

### CROSS-REFERENCE TO RELATED APPLICATIONS

This application claims the benefit of U.S. Provisional Application titled “TECHNIQUES FOR DEBANDING IN VIDEO CODING,” filed on Oct. 2, 2023, and having Ser. No. 63/587,406, and “TECHNIQUES FOR DEBANDING IN VIDEO CODING,” filed on Oct. 6, 2023, and having Ser. No. 63/588,667. The subject matter of these related applications is hereby incorporated by reference.

### BACKGROUND

### Field of the Various Embodiments

Embodiments of the present disclosure relate generally to computer science and video processing and, more specifically, to techniques for debanding in the in-loop filtering stage of a video coding pipeline.

### Description of the Related Art

Video content from a media title is commonly encoded to reduce the size of the video content and to convert the content into a format that is more suitable for broadcast, transmission, or playback on various devices or platforms. For example, video content from a movie or television show could be encoded into multiple versions that can be streamed to different endpoint devices. Each version of the video content could be associated with a certain encoding format, bit rate, frame rate, resolution, level of quantization, or other encoding settings that are optimized for streaming or playback on a particular set of endpoint device hardware and/or under a given set of network conditions. During encoding of video content from a media title, each video frame is divided into multiple blocks of fixed or varying sizes, and the portion of video content within each block is encoded. During playback of the media title on an endpoint device, the encoded blocks can be decoded and used to reconstruct the video frame.

In some instances, the encoding and decoding process described above introduces “banding” artifacts into reconstructed video frames. Banding artifacts are visual disruptions and/or distortions in reconstructed video frames that are not present in the original video content. Banding artifacts visually appear as striped regions and can sometimes be found in areas of a reconstructed video frame where a smooth transition between colors would otherwise occur. For example, banding artifacts are sometimes visible in portions of reconstructed video frames that are meant to depict a clear sky. Rather than depicting a smooth transition across many similar shades of blue, when banding artifacts are present, portions of the reconstructed video frames would instead display several abrupt transitions between just a few different shades of blue. As a general matter, banding artifacts are visually unappealing and are usually distracting to most viewers.

Banding artifacts can occur in many different coding implementations. Banding artifacts sometimes occur when directional intra-prediction coding techniques are used to encode and decode video content at higher quantization settings. In particular, the higher quantization settings can cause blocks/stretches of similar pixels to appear in reference samples. When the reference samples are subsequently used to reconstruct a portion of the video frame, these blocks are then replicated along the prediction direction, introducing a continuous region or “band” of similarly valued pixels into the portion of the reconstructed video frame. For example, when the prediction direction is top-to-bottom and left-to-right, blocks of similar pixels can sometimes be replicated across a portion of the reconstructed video frame, forming a diagonal band that extends from an upper-left area of the portion of the reconstructed video frame towards a lower-right area of the portion of the reconstructed video frame.

One approach to reducing banding is to perform “debanding” post-processing operations on each reconstructed video frame after decoding has occurred. During debanding post-processing, each reconstructed video frame is analyzed by hardware and/or software on the endpoint device to detect whether the reconstructed video frame includes any banding artifacts. To the extent banding artifacts are detected within a given reconstructed video frame, that reconstructed video frame is modified to reduce the visual impact of the detected banding artifacts. One drawback of this approach is that debanding post-processing operations are typically computationally intensive. Another drawback is that different endpoint devices typically implement different debanding post-processing operations due to varying hardware and/or software configurations, which can lead to inconsistent reductions in banding and inconsistent levels of visual quality across different endpoint devices.

As the foregoing illustrates, what is needed in the art are more effective techniques for reducing banding artifacts in decoded video data.

### SUMMARY

In various embodiments, a technique for reducing banding artifacts in decoded video data includes receiving a first block of reconstructed samples associated with a frame of encoded video data, applying a first filter to a first reconstructed sample included in the first block of reconstructed samples to generate a first filtered sample, determining that a first randomized dithering operation associated with the first filter is has been activated, applying the first randomized dithering operation to the first filtered sample to generate a first dithered sample, and generating a first portion of decoded video data based on the first dithered sample.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that incorporating randomized dithering operations into the in-loop filtering stage does not require the addition of any post-processing operations to the decoding pipeline. Accordingly, the disclosed techniques can be implemented without introducing additional blocks to the video decoding and processing pipeline. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a block diagram of a content server that may be implemented in conjunction with the network infrastructure of FIG. 1, according to various embodiments;

FIG. 3 is a block diagram of a control server that may be implemented in conjunction with the network infrastructure of FIG. 1, according to various embodiments; and

FIG. 4 is a block diagram of an endpoint device that may be implemented in conjunction with the network infrastructure of FIG. 1, according to various embodiments;

FIG. 5 is a more detailed illustration of the decoding pipeline of FIG. 4, according to various embodiments;

FIG. 6 is a more detailed illustration of the in-loop filtering stage of FIG. 5, according to various embodiments; and

FIG. 7 is a flow diagram of method steps for selectively dithering sample values across a sequence of in-loop filtering stages, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

Banding artifacts are visual disruptions and/or distortions in reconstructed video frames that are not present in the original video content. Banding artifacts visually appear as striped regions and can sometimes be found in areas of a reconstructed video frame where a smooth transition between colors would otherwise occur. Banding artifacts can occur in many different coding implementations. Banding artifacts can occur in many different coding implementations. For example, banding artifacts are sometimes caused by the in-loop filtering stage of a coding pipeline when a block of reconstructed sample values is filtered and subsequently normalized to a desired bit depth. More specifically, during a typical in-loop filtering stage, one or more different filters are applied sequentially to the block of reconstructed sample values in order to perform various refinements that generally serve to enhance overall picture quality. When filtering is complete, the block of filtered, reconstructed sample values is then normalized to produce a block of pixel values at a lower bit depth. However, many conventional decoding pipelines, when normalizing to the desired, lower bit depth, convert slightly different pixel values to the same value. Consequently, continuous regions or “bands” of similarly-valued pixels can appear as visible banding artifacts to viewers of the reconstructed frame.

One approach to reducing banding is to perform “debanding” post-processing operations on each reconstructed video frame after decoding has occurred. During debanding post-processing, each reconstructed video frame is analyzed by hardware and/or software on the endpoint device to detect whether the reconstructed video frame includes any banding artifacts. To the extent banding artifacts are detected within a given reconstructed video frame, that reconstructed video frame is modified to reduce the visual impact of the detected banding artifacts. One drawback of this approach is that debanding post-processing operations are typically computationally intensive and, therefore, can cause delays in playing back a media title. Another drawback is that different endpoint devices typically implement different debanding post-processing operations due to varying hardware and/or software configurations, which can lead to inconsistent reductions in banding and inconsistent levels of visual quality across different endpoint devices.

To address the above issues, a decoding pipeline is configured to implement an in-loop filtering stage that selectively applies one or more randomized dithering operations. The in-loop filtering stage includes a set of filters that process blocks of sample values to perform various enhancements and/or refinements. The set of filters includes a deblocking filter, a constrained directional enhancement filter (CDEF), and a loop restoration filter. Each filter in the set of filters can apply a randomized dithering operation to input samples to generate dithered samples. When applying the randomized dithering operation, a given filter generates a randomized value for a given sample based on one or more attributes of that sample and then adds the randomized value to a sample value associated with the given sample, resulting in a randomized sample value. The randomized sample value can then be rounded to provide a dithered sample. The in-loop filtering stage of the decoding pipeline can configure each filter independently to perform the randomized dithering, depending on encoding and/or decoding parameters.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that incorporating randomized dithering operations into the in-loop filtering stage does not require the addition of any post-processing operations to the decoding pipeline. Accordingly, the disclosed techniques can be implemented without introducing complex debanding algorithms during decoding or playback of a media title. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.

### System Overview

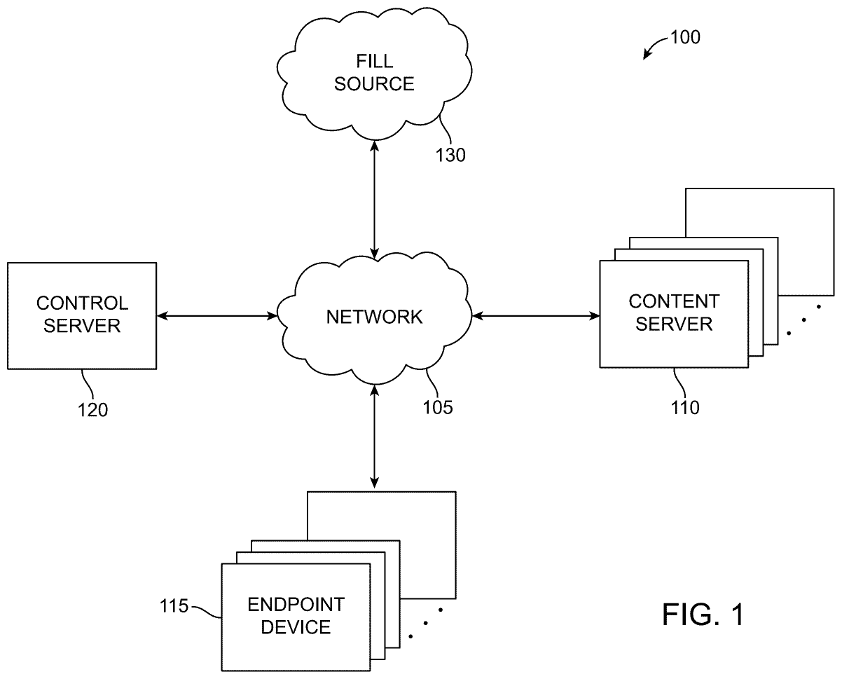

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

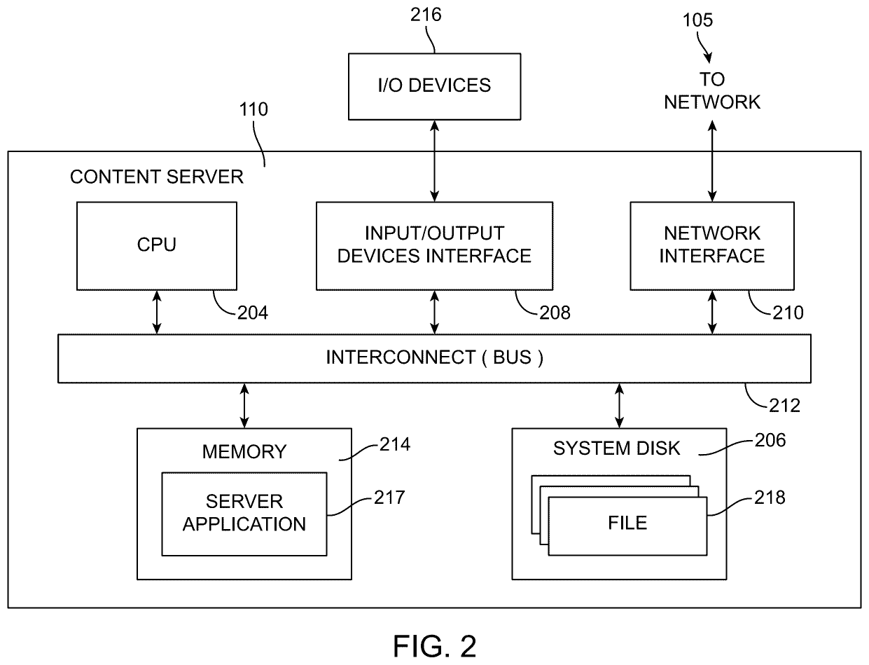

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

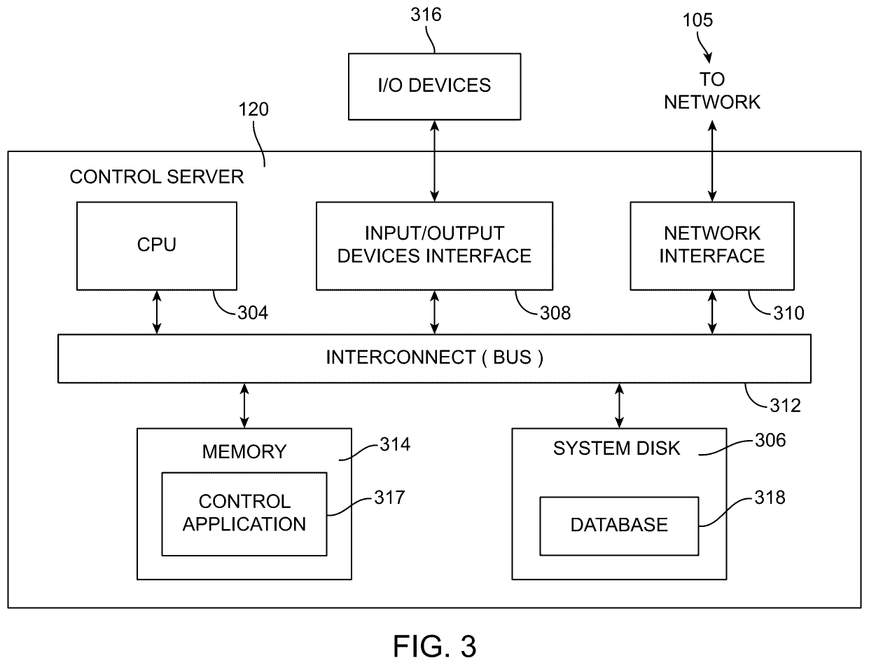

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

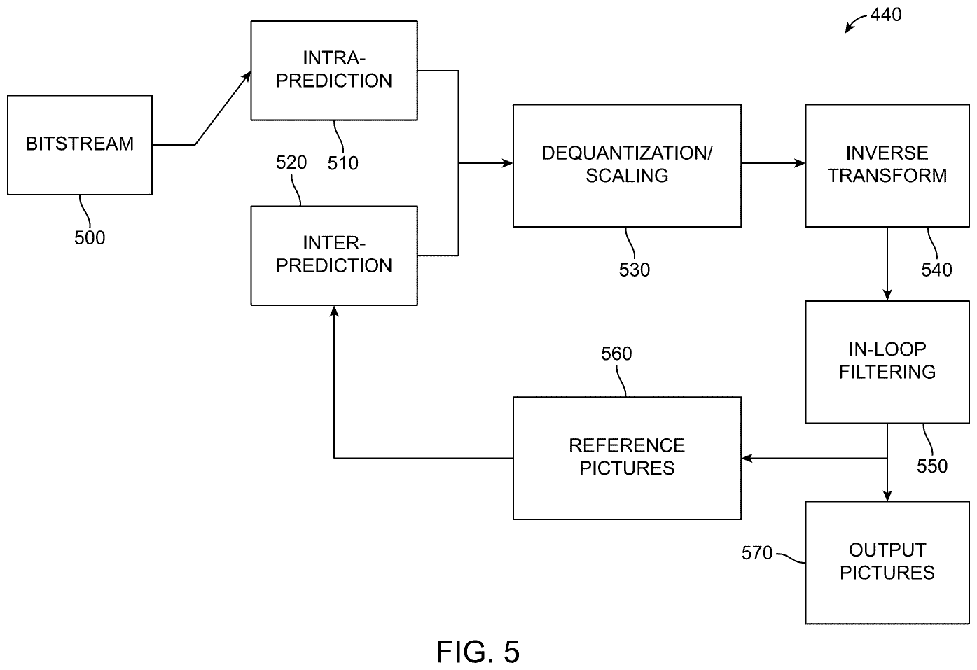

Referring generally to FIGS. 1-3, in various embodiments, the system 100 is configured to implement an encoding pipeline to compress audiovisual data associated with media titles prior to streaming to endpoint device(s) 115. For example, and without limitation, the content server 110 of FIGS. 1-2 could implement an encoding pipeline via server application 217 that compresses files 218 prior to transmission to an endpoint device 115. Alternatively, and without limitation, files stored in fill source 130 could be compressed, via an encoding pipeline within system 100, prior to storage. As described in greater detail below in conjunction with FIGS. 5-7, the encoding pipeline can analyze audiovisual data during encoding to determine specific optimizations that can subsequently be applied, during decoding on endpoint device 115, to reduce the presence of banding artifacts.

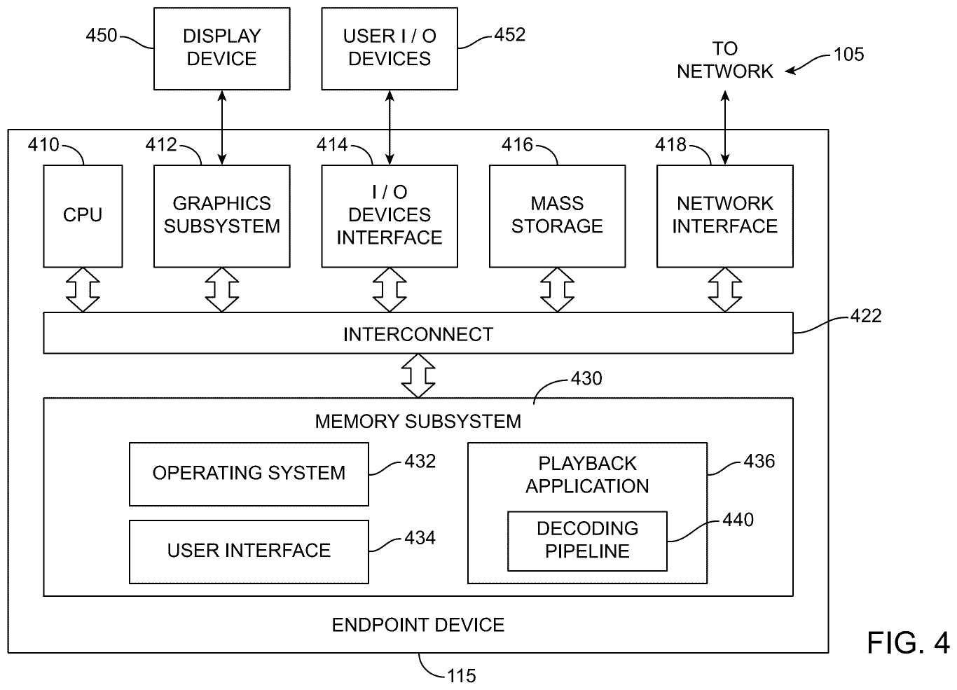

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 105 via the network interface 418. Further, the playback application 436 is configured to interpret the content and present the content via display device 450 and/or user I/O devices 452. In so doing, the playback application 436 includes a decoding pipeline 440 that decodes compressed content prior to display via display device. Decoding pipeline 440 is described in greater detail below in conjunction with FIG. 5.

### Debanding in the In-Loop Filtering Stage of Coding Pipeline

FIG. 5 is a more detailed illustration of the decoding pipeline of FIG. 4, according to various embodiments. As shown, decoding pipeline 440 receives bitstream 500 and generates output pictures 570. Bitstream 500 generally includes compressed frames of video data, whereas output pictures 570 includes decompressed frames of video data. Decoding pipeline 440 includes various decoding stages, including intra-prediction 510, inter-prediction 520, dequantization/descaling 530, inverse transform 540, and in-loop filtering 550.

Intra-prediction 510 is a decoding stage that generates reconstructed frames of video data using intra-prediction decoding techniques. Inter-prediction 520 is a decoding stage that can generate reconstructed frames of video data using inter-prediction decoding techniques. Dequantization/scaling 530 is a decoding stage where various quantized coefficients are scaled based on one or more quantization parameters. Inverse transform 540 is a decoding stage that converts scaled coefficients output by dequantization/scaling 530 between different domains. In-loop filtering 550 is a decoding stage that applies various filters to reconstructed frames of video data. In-loop filtering 550 generates reference pictures 560 that can be subsequently used by inter-prediction 520, as well as output pictures 570 mentioned above, which can be displayed via display device 450.

Various stages of decoding pipeline 440 can be configured to implement specific operations that can reduce the presence of banding artifacts in output pictures 570. In particular, intra-prediction 510, inverse transform 540, and in-loop filtering 550 can each be configured to implement different types of filtering and/or randomized dithering operations to mitigate or at least partially prevent banding artifacts. These operations can be performed by the decoding stages mentioned above independently of one another or in any technically feasible combination with one another.

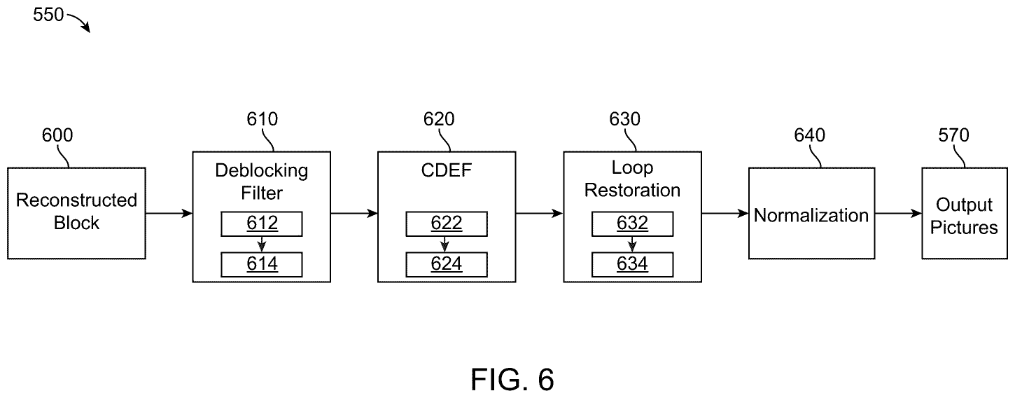

In various embodiments, during encoding of compressed frames of video data included in bitstream 500, an encoding pipeline analyzes frames of video data and determines, for a given set of frames, specific combinations and/or configurations of decoding stages that should implement the aforesaid operations during decoding to reduce banding artifacts in that set of frames. For example, and without limitation, the encoding pipeline could determine that for a given set of frames, intra-prediction 510 should filter reference samples using specific parameters, inverse transform 540 should implement randomized dithering operations, and in-loop filtering 550 should operate using an increased bit depth. The encoding pipeline may implement any technically feasible criteria to determine which configurations to apply when decoding any given set of frames. Various operations that can be implemented by inverse transform 540 are described in greater detail below in conjunction with FIG. 6.

FIG. 6 is a more detailed illustration of the in-loop filtering stage of FIG. 5, according to various embodiments. As shown, in-loop filtering 550 receives reconstructed block 600 of samples and generates output pictures 570. Reconstructed block 600 of samples can be generated using various reconstruction techniques. In one embodiment, intra-prediction 510 or inter-prediction 520 of FIG. 5 may generate a predicted block of samples, inverse transform 540 may generate a residual block of samples, and inverse transform 540 may then generate reconstructed block 600 of samples by combining the predicted block of samples with the residual block of samples. Reconstructed block 600 of samples and output pictures 570 can have any given bit depth, although in some configurations the bit depth of output pictures 570 is lower than that associated with reconstructed block 600 of samples.

In-loop filtering 550 includes deblocking filter 610, constrained directional enhancement filter (CDEF) 620, loop restoration 630, and normalization 640. Deblocking filter 610 is configured to perform deblocking operations on input samples by modifying sample values that reside adjacent to a block boundary. Deblocking filter 610 includes dithering 612. Dithering 612 is configured to perform a randomized dithering operation to generate dithered samples 614. The randomized dithering operation is described in greater detail below. CDEF 620 is configured to perform a constrained directional enhancement operation on input samples to smooth edges. CDEF 620 includes dithering 622 that, like dithering 612, is configured to perform a randomized dithering operation that is described in greater detail below. Dithering 622 generated dithered samples 624. Loop restoration 630 is configured to implement a Wiener filter, a Self-Guided Restoration (SGR) filter, and/or other types of restoration filters based on input samples to generally improve picture quality and detail. Loop restoration 630 includes dithering 632 that is configured to perform a randomized dithering operation to generate dithered samples 634. Normalization 640 modifies input samples to adjust the bit depth of those samples to that associated with output pictures 570.

Deblocking filter 610, CDEF 620, and loop restoration 630 can selectively apply dithering 612, 622, and 632, respectively, in order to generate output samples that are provided to a subsequent stage of in-loop filtering 550 as input samples. In various configurations, in-loop filtering 550 causes some filtering stages to implement dithering and not others. For example, and without limitation, in-loop filtering 550 could configure deblocking filter 612 to not implement dithering 612. Deblocking filter 610 would then output deblocked samples to CDEF 620 without performing the randomized dithering operation. In-loop filtering 550 could further configure CDEF 620 to implement dithering 622 with deblocked samples received from deblocking filter 610. As a general matter, for any given reconstructed block of samples, in-loop filtering 550 can individually configure each filtering stage to either perform or not perform the randomized dithering operation on input samples. In one embodiment, in-loop filtering 550 may selectively activate or deactivate each of dithering 612, 622, and 632 based on coding parameters determined by an encoding pipeline and transmitted within bitstream 500. In another embodiment, decoding pipeline 440 of FIGS. 4-5 determines a configuration of dithering 612, 622, and 632 based on current decoding parameters and/or conditions.

In one embodiment, dithering 612, 622, and 632 may implement the randomized dithering operation for a given sample by generating a randomized value based on one or more attributes of the given sample. The randomized value is then added to a sample value associated with the sample to generate a randomized sample value. The one or more attributes may be a set of local or global coordinates associated with the sample. The randomized sample value may then be rounded to provide a dithered sample value. An example of the randomized dithering operation is denoted below, without limitation:

$${x}_{ij}^{′} = ( {x}_{sum , ij} + ran d ( i , j ) ) ≫ s \qquad ( 1 )$$

In expression (1), a given sample with coordinates i and j is modified by taking a weighted sum of adjacent sample values and then adding a randomized value provided by rand(i, j). In one embodiment, the randomized value may be scaled and/or subject to a bias in order to provide stronger or weaker dithering and/or to adjust the range of possible random values. The resultant randomized sample value is then rounded via bit shifting to generate a dithered sample value. In some implementations, rounding is performed during normalization 640 when bit depth is reduced. An example randomization function is denoted below, without limitation:

$$rand ( i , j ) = ra\_num [ ( j * mcol + i ⋆ mrow ) \& 31 ] \qquad ( 2 )$$

$$ra\_num \_part [ 32 ] = \{ 12 , 0 , 6 , 4 , 15 , 12 , 6 , 11 , 11 , 9 , 15 , 12 , 9 , 1 , 14 , 4 , 7 , 5 , 12 , 13 , 13 , 14 , 1 , 11 , 8 , 5 , 9 , 6 , 3 , 4 , 2 , 2 \} \qquad ( 3 )$$

In expression (2), mrow and mcol are multipliers for coordinates i and j, respectively. Expression (3) is a pseudo-random array that is indexed in the manner shown based on i, j, mrow, and mcol. Referring generally to expressions (1) through (3), the randomized dithering operation can be implemented via any technically feasible part or combination of these expressions. For example, and without limitation, the randomized dithering operation could be performed by adding a randomized value to a given sample value. Alternatively, without limitation, the randomized dithering operation could be implemented by adding a randomized sample value to a weighted sum of sample values. In yet another alternative, the randomized dithering operation could be implemented by adding a randomized value to a weighted sum of sample values, and then rounding the result to a lower bit depth. Any of dithering 612, 622, and 632 can perform any of the aforementioned alternatives.

Via the techniques described above, in-loop filtering 550 dithers sample values which are then used to generate frames of decoded video data included in output pictures 570. The randomized dithering approach described thus far advantageously reduces banding artifacts by preventing the formation of well-defined and abrupt gradients between color values.

In various embodiments, intra-prediction 510 and/or inverse transform 540 within decoding pipeline 440 of FIG. 5 may implement randomized dithering operations such as those described above to modify sample values. Referring generally to FIGS. 4-6, decoding pipeline 440 and the various components described can implement any combination of the disclosed techniques independently or in conjunction with one another in order to reduce banding artifacts. Further, persons skilled in the art will understand how the techniques described herein relative to decoding pipeline 440 can also be implemented within analogous stages of a corresponding encoding pipeline. For example, and without limitation, the various operations described above with regard to in-loop filtering 550 could also be implemented within an in-loop filtering stage of an encoding pipeline. In one embodiment, decoding pipeline 440 may configure intra-prediction 510 and inverse transform 540 to process blocks of samples at a first bit depth that exceeds a target bit depth associated with output pictures 570. Decoding pipeline 440 may then implement a randomized dithering operation prior to in-loop filtering 550 to dither sample values and reduce bit depth from the first bit depth to the target bit depth. In an alternative embodiment, decoding pipeline 440 may implement the randomized dithering operation after in-loop filtering 550 to dither sample values and reduce bit depth from the first bit depth to the target bit depth. Blocks of dithered sample values may subsequently be converted to pixel values that form a portion of a decoded frame of video data. Persons skilled in the art will understand that, as a general matter, decoding pipeline 440 may operate at a higher bit depth than the output bit depth and without adding dithering between certain decoding stages. Further, when dithering occurs between stages, bit depth may be decreased to an output bit depth.

As a general matter, decoding pipeline 440 can configure each of intra-prediction 510, inverse transform 540, and in-loop filtering 550 separately to perform randomized dithering operations on samples based on various coding parameters. Those coding parameters could include, for example and without limitation, an encoding mode, a decoding mode, a prediction mode, a block size, a distortion level, a bit rate, a bit depth, a cost metric, and so forth. Any given coding parameter can be associated with the encoding pipeline or any stage of the encoding pipeline and/or decoding pipeline 440 or any stage of decoding pipeline 440. In one embodiment, the encoding pipeline may transmit coding parameters in bitstream 500, and decoding pipeline 440 may then analyze these coding parameters in order to selectively activate randomized dithering operations within intra-prediction 510, inverse transform 540, and/or in-loop filtering 550, and/or any specific filter within in-loop filtering 550. For example, and without limitation, the encoding pipeline could perform a rate-distortion optimization (RDO) process during encoding, and then selectively configure coding parameters in bitstream 500 based on one or more metrics derived from the RDO process. Decoding pipeline 440 would then evaluate those coding parameters and selectively activate randomized dithering within intra-prediction 510, inverse transform 540, and/or in-loop filtering 550, and/or any specific filter within in-loop filtering 550. The coding parameters could be, for example and without limitation, a set of bits indicating, for any given sample, block of samples, or frame of encoded video data, the specific elements of decoding pipeline 440 where randomized dithering operations should be activated.

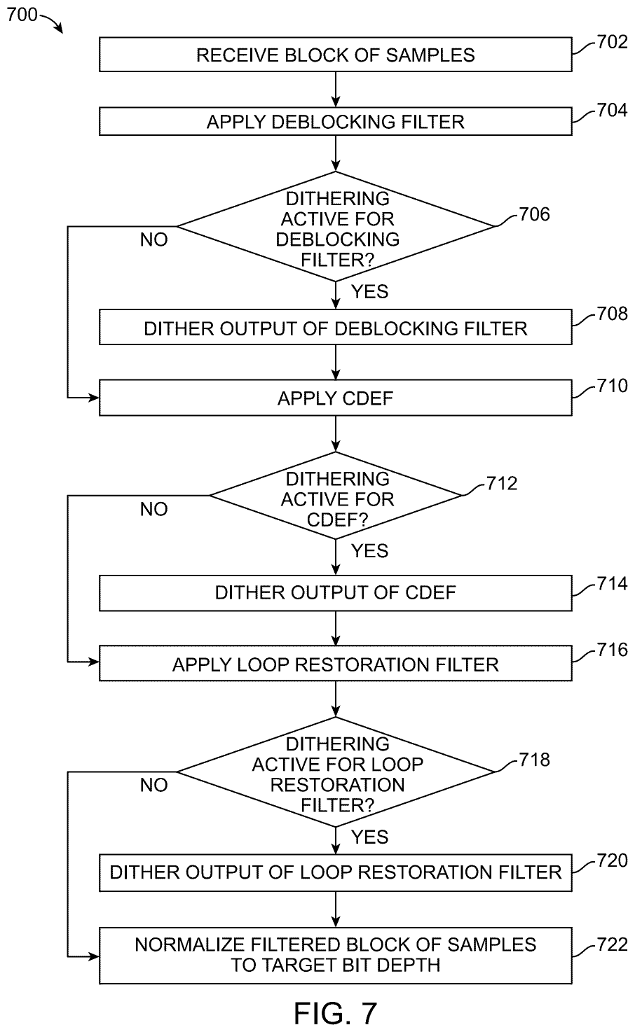

FIG. 7 is a flow diagram of method steps for selectively dithering sample values during a sequence of in-loop filtering stages, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where in-loop filtering 550 receives reconstructed block 600 of samples. Reconstructed block 600 of samples can be generated using various reconstruction techniques. In one embodiment, intra-prediction 510 or inter-prediction 520 of FIG. 5 may generate a predicted block of samples, inverse transform 540 may generate a residual block of samples, and inverse transform 540 may then generate reconstructed block 600 of samples by combining the predicted block of samples with the residual block of samples. In some configurations, reconstructed block 600 of samples has a higher bit depth compared to output pictures 570.

At step 704, in-loop filtering 550 applies deblocking filter 610. Deblocking filter 610 is configured to perform deblocking operations on input samples by modifying sample values that reside adjacent to a block boundary. Deblocking filter 610 selectively applies dithering 612 depending on whether dithering 612 is active. At step 706, if dithering 612 is active, then the method 700 proceeds to step 708 where the randomized dithering operation is applied to generate dithered samples 614. If at step 706 dithering 612 is not active, then the method 700 proceeds to step 710.

At step 710, in-loop filtering 550 applies CDEF 620. CDEF 620 is configured to perform a constrained directional enhancement operation on input samples to smooth edges. The input samples may be dithered samples 614 or deblocked samples that are not dithered, depending on whether step 708 is performed. CDEF 620 selectively applies dithering 622 depending on whether dithering 622 is active. At step 712, if dithering 622 is active, then the method 700 proceeds to step 714 where the randomized dithering operation is applied to generate dithered samples 624. If at step 712 dithering 622 is not active, then the method 700 proceeds to step 716.

At step 716, in-loop filtering 550 applies loop restoration 630. Loop restoration 630 is configured to implement a Wiener filter, an SGR filter, and/or other types of restoration filters based on input samples to generally enhance picture quality and detail. The input samples may be dithered samples 624 or filtered samples output by CDEF 620, depending on whether step 712 is performed. Loop restoration 630 selectively applies dithering 632 depending on whether dithering 718 is active. At step 718, if dithering 632 is active, then the method 700 proceeds to step 720 where the randomized dithering operation is applied to generate dithered samples 634. If at step 718 dithering 632 is not active, then the method 700 proceeds to step 722.

At step 722, normalization 640 is configured to adjust the bit depth of input samples to that associated with output pictures 570. For example, and without limitation, normalization 640 could round sample values to a target bit depth associated with output pictures 570 or perform a bit shift operation with sample values. In various embodiments, some functionality of normalization 640 may be performed during any of the aforementioned randomized dithering operations.

In sum, a decoding pipeline is configured to implement an in-loop filtering stage that selectively applies one or more randomized dithering operations. The in-loop filtering stage includes a set of filters that process blocks of sample values to perform various enhancements and/or refinements. The set of filters includes a deblocking filter, a constrained directional enhancement filter (CDEF), and a loop restoration filter. Each filter in the set of filters can apply a randomized dithering operation to input samples to generate dithered samples. When applying the randomized dithering operation, a given filter generates a randomized value for a given sample based on one or more attributes of that sample and then adds the randomized value to a sample value associated with the given sample, resulting in a randomized sample value. The randomized sample value can then be rounded to provide a dithered sample. The in-loop filtering stage of the decoding pipeline can configure each filter independently to perform the randomized dithering, depending on encoding and/or decoding parameters.

At least one technical advantage of the disclosed techniques relative to the prior art is that the disclosed techniques enable the decoding pipeline to reduce the appearance of banding artifacts in reconstructed frames of video data, thereby resulting in greater overall visual quality and higher-quality viewing experiences when streaming media titles. Another technical advantage of the disclosed techniques is that incorporating randomized dithering operations into the in-loop filtering stage does not require the addition of any post-processing operations to the decoding pipeline. Yet another technical advantage of the disclosed techniques is that the disclosed decoding pipeline can be deployed to different types of endpoint devices, which can lead to more consistent debanding performance and visual quality across different endpoint devices having different hardware and/or software configurations. These technical advantages provide one or more technological improvements over prior art approaches.

1. Some embodiments include a computer-implemented method for reducing banding artifacts in decoded video data, the method comprising receiving a first block of reconstructed samples associated with a frame of encoded video data, applying a first filter to a first reconstructed sample included in the first block of reconstructed samples to generate a first filtered sample, determining that a first randomized dithering operation associated with the first filter is has been activated, applying the first randomized dithering operation to the first filtered sample to generate a first dithered sample, and generating a first portion of decoded video data based on the first dithered sample.

2. The computer-implemented method of clause 1, further comprising generating the first block of reconstructed samples by performing at least one prediction operation on a block of reference samples to generate a block of predicted samples, performing at least one inverse transform operation on a block of coefficients to generate a block of residual samples, and combining the block of predicted samples with the block of residual samples to generate the first block of reconstructed samples.

3. The computer-implemented method of any of clauses 1-2, wherein applying the first filter comprises performing at least one deblocking operation on one or more reconstructed samples included in the first block of reconstructed samples.

4. The computer-implemented method of any of clauses 1-3, wherein applying the first filter comprises performing at least one constrained directional enhancement operation on one or more reconstructed samples included in the first block of reconstructed samples.

5. The computer-implemented method of any of clauses 1-4, wherein applying the first filter comprises performing at least one Wiener filtering operation on one or more reconstructed samples included in the first block of reconstructed samples.

6. The computer-implemented method of any of clauses 1-5, wherein determining that the first randomized dithering operation has been activated comprises determining that an encoding pipeline encoded the frame of encoded video data using a first set of encoding parameters.

7. The computer-implemented method of any of clauses 1-6, wherein determining that the first randomized dithering operation has been activated comprises determining that a decoding pipeline that includes the first filter currently implements a first set of decoding parameters.

8. The computer-implemented method of any of clauses 1-7, wherein applying the first randomized dithering operation to the first filtered sample comprises generating a first randomized value based on at least one attribute of the first filtered sample, adding the first randomized value to a first filtered sample value associated with the first filtered sample to generate a first randomized sample value, and applying a bit shift operation to the first randomized sample value to generate a first dithered sample value corresponding to the first dithered sample.

9. The computer-implemented method of any of clauses 1-8, wherein applying the first randomized dithering operation to the first filtered sample comprises modifying a first filtered sample value associated with the first filtered sample based on at least one attribute of the first filtered sample.

10. The computer-implemented method of any of clauses 1-9, wherein the first reconstructed block of samples is associated with a first bit depth, the first portion of video data is associated with a second bit depth, and the first bit depth is greater than the second bit depth.

11. The computer-implemented method of any of clauses 1-10, wherein the first reconstructed block of samples is associated with a first bit depth, and the first portion of video data is also associated with the first bit depth.

12. Some embodiments include one or more non-transitory computer-readable media including instructions that, when executed by one or more processors, cause the one or more processors to reduce banding artifacts in decoded video data by performing the steps of receiving a first block of reconstructed samples associated with a frame of encoded video data, applying a first filter to a first reconstructed sample included in the first block of reconstructed samples to generate a first filtered sample, determining that a first randomized dithering operation associated with the first filter is has been activated, applying the first randomized dithering operation to the first filtered sample to generate a first dithered sample, and generating a first portion of decoded video data based on the first dithered sample.

13. The one or more non-transitory computer-readable media of clause 12, further comprising the step of generating the first block of reconstructed samples by performing at least one prediction operation on a block of reference samples to generate a block of predicted samples, performing at least one inverse transform operation on a block of coefficients to generate a block of residual samples, and combining the block of predicted samples with the block of residual samples to generate the first block of reconstructed samples.

14. The one or more non-transitory computer-readable media of any of clauses 12-13, wherein the step of applying the first filter comprises performing at least one deblocking operation on one or more reconstructed samples included in the first block of reconstructed samples.

15. The one or more non-transitory computer-readable media of any of clauses 12-14, wherein the step of applying the first filter comprises performing at least one constrained directional enhancement operation on one or more reconstructed samples included in the first block of reconstructed samples.

16. The one or more non-transitory computer-readable media of any of clauses 12-15, wherein the step of applying the first filter comprises performing at least one loop restoration or Wiener filtering operation on one or more reconstructed samples included in the first block of reconstructed samples.

17. The one or more non-transitory computer-readable media of any of clauses 12-16, wherein the step of determining that the first randomized dithering operation has been activated comprises determining that an encoding pipeline performed a rate distortion optimization when encoding the frame of encoded video data.

18. The one or more non-transitory computer-readable media of any of clauses 12-17, wherein the step of determining that the first randomized dithering operation has been activated comprises determining that a decoding pipeline that includes the first filter is currently configured to perform a first prediction operation when decoding the frame of encoded video data.

19. The one or more non-transitory computer-readable media of any of clauses 12-18, wherein the step of applying the first randomized dithering operation to the first filtered sample comprises modifying a first filtered sample value associated with the first filtered sample based on at least one attribute of the first filtered sample.

20. The one or more non-transitory computer-readable media of any of clauses 12-19, further comprising the steps of applying a second filter to the first dithered sample to generate a second filtered sample, determining that a second randomized dithering operation associated with the second filter is has been activated, and applying the second randomized dithering operation to the second filtered sample to generate a second dithered sample, wherein the first portion of decoded video data is further generated based on the second dithered sample.

21. Some embodiments include a system comprising one or more memories storing instructions, and one or more processors coupled to the one or more memories that, when executing the instructions, perform the steps of receiving a first block of reconstructed samples associated with a frame of encoded video data, applying a first filter to a first reconstructed sample included in the first block of reconstructed samples to generate a first filtered sample, determining that a first randomized dithering operation associated with the first filter is has been activated, applying the first randomized dithering operation to the first filtered sample to generate a first dithered sample, and generating a first portion of decoded video data based on the first dithered sample.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for reducing banding artifacts in decoded video data, the method comprising:
receiving a first block of reconstructed samples associated with a frame of encoded video data;
applying a first filter to a first reconstructed sample included in the first block of reconstructed samples to generate a first filtered sample;
determining that a first randomized dithering operation associated with the first filter is has been activated;
applying the first randomized dithering operation to the first filtered sample to generate a first dithered sample; and
generating a first portion of decoded video data based on the first dithered sample.

2. The computer-implemented method of claim 1, further comprising generating the first block of reconstructed samples by:
performing at least one prediction operation on a block of reference samples to generate a block of predicted samples;
performing at least one inverse transform operation on a block of coefficients to generate a block of residual samples; and
combining the block of predicted samples with the block of residual samples to generate the first block of reconstructed samples.

3. The computer-implemented method of claim 1, wherein applying the first filter comprises performing at least one deblocking operation on one or more reconstructed samples included in the first block of reconstructed samples.

4. The computer-implemented method of claim 1, wherein applying the first filter comprises performing at least one constrained directional enhancement operation on one or more reconstructed samples included in the first block of reconstructed samples.

5. The computer-implemented method of claim 1, wherein applying the first filter comprises performing at least one Wiener filtering operation on one or more reconstructed samples included in the first block of reconstructed samples.

6. The computer-implemented method of claim 1, wherein determining that the first randomized dithering operation has been activated comprises determining that an encoding pipeline encoded the frame of encoded video data using a first set of encoding parameters.

7. The computer-implemented method of claim 1, wherein determining that the first randomized dithering operation has been activated comprises determining that a decoding pipeline that includes the first filter currently implements a first set of decoding parameters.

8. The computer-implemented method of claim 1, wherein applying the first randomized dithering operation to the first filtered sample comprises:
generating a first randomized value based on at least one attribute of the first filtered sample;
adding the first randomized value to a first filtered sample value associated with the first filtered sample to generate a first randomized sample value; and
applying a bit shift operation to the first randomized sample value to generate a first dithered sample value corresponding to the first dithered sample.

9. The computer-implemented method of claim 1, wherein applying the first randomized dithering operation to the first filtered sample comprises modifying a first filtered sample value associated with the first filtered sample based on at least one attribute of the first filtered sample.

10. The computer-implemented method of claim 1, wherein the first reconstructed block of samples is associated with a first bit depth, the first portion of video data is associated with a second bit depth, and the first bit depth is greater than the second bit depth.

11. The computer-implemented method of claim 1, wherein the first reconstructed block of samples is associated with a first bit depth, and the first portion of video data is also associated with the first bit depth.

12. One or more non-transitory computer-readable media including instructions that, when executed by one or more processors, cause the one or more processors to reduce banding artifacts in decoded video data by performing the steps of:
receiving a first block of reconstructed samples associated with a frame of encoded video data;
applying a first filter to a first reconstructed sample included in the first block of reconstructed samples to generate a first filtered sample;
determining that a first randomized dithering operation associated with the first filter is has been activated;
applying the first randomized dithering operation to the first filtered sample to generate a first dithered sample; and
generating a first portion of decoded video data based on the first dithered sample.

13. The one or more non-transitory computer-readable media of claim 12, further comprising the step of generating the first block of reconstructed samples by:
performing at least one prediction operation on a block of reference samples to generate a block of predicted samples;
performing at least one inverse transform operation on a block of coefficients to generate a block of residual samples; and
combining the block of predicted samples with the block of residual samples to generate the first block of reconstructed samples.

14. The one or more non-transitory computer-readable media of claim 12, wherein the step of applying the first filter comprises performing at least one deblocking operation on one or more reconstructed samples included in the first block of reconstructed samples.

15. The one or more non-transitory computer-readable media of claim 12, wherein the step of applying the first filter comprises performing at least one constrained directional enhancement operation on one or more reconstructed samples included in the first block of reconstructed samples.

16. The one or more non-transitory computer-readable media of claim 12, wherein the step of applying the first filter comprises performing at least one loop restoration or Wiener filtering operation on one or more reconstructed samples included in the first block of reconstructed samples.

17. The one or more non-transitory computer-readable media of claim 12, wherein the step of determining that the first randomized dithering operation has been activated comprises determining that an encoding pipeline performed a rate distortion optimization when encoding the frame of encoded video data.

18. The one or more non-transitory computer-readable media of claim 12, wherein the step of determining that the first randomized dithering operation has been activated comprises determining that a decoding pipeline that includes the first filter is currently configured to perform a first prediction operation when decoding the frame of encoded video data.

19. The one or more non-transitory computer-readable media of claim 12, wherein the step of applying the first randomized dithering operation to the first filtered sample comprises modifying a first filtered sample value associated with the first filtered sample based on at least one attribute of the first filtered sample.

20. The one or more non-transitory computer-readable media of claim 12, further comprising the steps of:
applying a second filter to the first dithered sample to generate a second filtered sample;
determining that a second randomized dithering operation associated with the second filter is has been activated; and
applying the second randomized dithering operation to the second filtered sample to generate a second dithered sample,
wherein the first portion of decoded video data is further generated based on the second dithered sample.

21. A system comprising:
one or more memories storing instructions; and
one or more processors coupled to the one or more memories that, when executing the instructions, perform the steps of:
receiving a first block of reconstructed samples associated with a frame of encoded video data,
applying a first filter to a first reconstructed sample included in the first block of reconstructed samples to generate a first filtered sample,
determining that a first randomized dithering operation associated with the first filter is has been activated,
applying the first randomized dithering operation to the first filtered sample to generate a first dithered sample, and
generating a first portion of decoded video data based on the first dithered sample.
